(19) United States
(12) Patent Application Publication
(10) Pub. No.: US 2009/0170364 A1
(43) Pub. Date: Jul. 2, 2009

(54) ELECTRICAL CONNECTOR

(76) Inventors: Johann Scholler, Deggendorf (DE); Sonja Fredl, Deggendorf (DE)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 12/298,932

(22) PCT Filed: Feb. 4, 2008
(86) PCT No.: PCT/DE08/00187

§ 371 Date: Dec. 23, 2008

(30) Foreign Application Priority Data
Feb. 7, 2007 (DE) 20-2007-002-41.4

(51) Int. Cl. H01R 13/622

(52) U.S. Cl. 439/359

(57) ABSTRACT

The invention relates to an electrical connector, comprising a connector part and a mating connector part which can be plugged together, and a coupling ring, carried by the connector part, for screwing the connector part with a threaded sleeve of the mating connector part. An outer thread of the threaded sleeve and a correspondingly configured inner thread of the coupling ring have at least one unthreaded section each in the direction of insertion. The respective unthreaded and threaded sections are configured and arranged in such a manner that the threaded sections of the coupling ring and the threaded sleeve can be inserted into the respective unthreaded section of the other connector part in order to plug the connector and mating connector together. The connector according to the invention is characterized by at least one raised annular collar section in front of at least one unthreaded section of the coupling ring in the direction of insertion, said annular collar section allowing the coupling ring to be rotated, when the connector is plugged together, once the annular collar section has passed the unthreaded section of the thread of the threaded sleeve.

### TECHNICAL FIELD OF THE INVENTION

The invention relates to an electrical connector, comprising a connector part and a mating connector part which can be plugged together, and a coupling ring, carried by the connector part, for screwing the connector part with a threaded sleeve of the mating connector part, according to the preamble of claim 1.

### DISCUSSION OF RELATED ART

Such connectors are generally known and are preferably used for electrical connections that are to be connected and disconnected quickly and in a simple manner. After they are connected, the coupling ring secures the connector part and the mating connector part against unintended disconnection. For this purpose, the coupling ring that has an inner thread is commonly screwed onto a mating outer thread of the mating connector part until it reaches an axial stop, and is then tightened so that the screwed connection cannot come apart. A disadvantage of such known connectors with standard thread is the amount of time required for connecting or disconnecting such a plug connection.

As a remedy for this disadvantage, other connectors are known where the outer thread of the mating connector part and the inner thread of the coupling ring have threaded and unthreaded sections in the direction of insertion that are configured and arranged in such a manner that the threaded sections can be inserted in the respective unthreaded sections of the connector part and of the mating connector part, respectively, in order to plug the connector and mating connector together. After the electrical connection has been established by inserting the connector part and the mating connector part into each other, the connector can be locked by turning the coupling ring. Quick assembly or disassembly is accomplished by the coupling ring requiring no more than one turn to achieve its locking action.

Such a connector is disclosed in DE 102 33 075 B4. The patent disclosure teaches an electrical connector with a connector part forming a threaded sleeve for screwing on a coupling ring of a mating connector part that can be plugged into the connector part, with the outer thread of the threaded sleeve having at least one unthreaded section provided on its outer diameter in the direction of insertion or screwing, where an inner thread of the coupling ring, its circumference matching the unthreaded section of the outer thread, can be inserted in and tightened on the unthreaded section of the outer thread.

It is considered to be a disadvantage of the described connector that it is possible to turn the coupling ring even when the connector has not been fully plugged together. In such a case, although the connector part and the mating connector part can be tightened and thereby locked together by several turns of the coupling ring, the advantage of quick assembly and disassembly is not ensured.

### SUMMARY OF THE INVENTION

The invention therefore addresses the problem of proposing an electrical connector where the turning of the coupling ring is prevented as long as the connector part and the mating connector part are not completely plugged together.

According to the invention, this problem is solved by an electrical connector with the characteristics of claim 1. Additional advantageous implementations are given in the subclaims.

In the electrical connector according to the invention, at least one raised annular collar section is located in front of at least one unthreaded section of the coupling ring in the direction of insertion. When the connector part and the mating connector part are plugged together, said annular collar section engages the unthreaded section of the outer thread of the threaded sleeve of the mating connector part and allows the coupling ring to be rotated only after the annular collar section has passed the unthreaded section. Then it is possible for the coupling ring to be turned in order to lock the connector so that the inner thread of the coupling ring and the outer thread of the threaded sleeve engage each other, with the raised annular collar section engaging behind a course of thread, preferably the last course of thread of the outer thread of the threaded sleeve, in the direction of insertion. Ideally, no more than half a turn of the coupling ring is required for locking the connector which ensures a quick connection and disconnection of the electrical connection.

Advantageously, the raised annular collar section and the thread-bearing section of the inner thread in the circumferential direction of the coupling ring are of identical length and in alignment with each other. This ensures that the courses of thread of the inner thread of the coupling ring and of the outer thread of the threaded sleeve do not unintentionally engage laterally to a small extent when the connector part is plugged into the mating connector part, thereby preventing a quick plugging action. The same applies to the disconnection of the plug connection.

Preferably, the raised annular collar section and the threaded section of the coupling ring have an identical contour in the direction of insertion. This has a favorable effect on the process time during the production of the coupling ring, thereby reducing the costs per piece.

In a preferred embodiment of the invention, a receptacle space for the raised annular collar section of the coupling ring is provided in the direction of insertion behind a course of thread of the threaded section of the mating connector part. The receptacle space may be placed in the threaded section between the courses of thread or after the courses of thread. Depending on its placement, it is limited by a course of thread on one or on both sides. Preferably, the receptacle space is formed behind the last course of thread of the threaded sleeve in the direction of insertion, and it may be limited by a circular annular collar on a side facing away from the outer thread. The receptacle space must have a width that is greater than the thickness of the raised annular collar section in the direction of insertion, with the thickness of the raised annular collar section being essentially determined by the thread pitch of the thread of the coupling ring and the threaded sleeve, respectively, corresponding to at least a single, preferably a double course of thread (thread pitch).

In one implementation of the invention, the raised annular collar section is parallel to the courses of thread of the inner thread and has the form of a section of a course of thread. The section of the course of thread may have the form of a sharp thread, a flat thread, or a trapezoidal thread and be intended for engaging a corresponding threaded section of the receptacle space. Here, it is important that the raised annular collar section shaped as a course of thread has a pitch that is identical with the courses of thread of the threaded sleeve and the coupling ring, with a different cross-sectional shape.

In an advantageous implementation of the connector according to the invention, a length of the threaded section of the outer thread of the threaded sleeve, measured in the circumferential direction, is a multiple of the threaded section of the inner thread of the coupling ring. Thus, the threaded section of the coupling ring is distinctly shorter than the threaded section of the threaded sleeve which has the consequence that the rotation of the coupling ring leads to an optimal overlap in the circumferential direction. In this manner, when the coupling ring is rotated, the inner thread and the outer thread engage over a large circumferential area before the threaded sections disengage again.

Depending on the thread pitch of the threaded sections, this makes it possible to compensate to a large extent for large tolerances of the mating connector part, for example a different position of the threaded section of the mating connector part in the direction of insertion relative to a face side of the threaded sleeve that faces the connector part. This ensures that after the coupling ring is tightened, the threaded sleeve with its face side contacts and is pressed against an associated face side of the connector part.

Serving the purpose especially well is an implementation with two threaded and unthreaded sections each, with the threaded sections having a length ratio in the circumferential direction of at least 3:1. With more than two unthreaded sections and/or a distinctly smaller length ratio, an optimal overlap over a wide circumferential area is not ensured when rotating the coupling ring.

The connector according to the invention comprises at least one unthreaded section each in the direction of insertion, and at least one adjacent threaded section in the circumferential direction, both being formed and arranged in such a manner that when the connector part and the mating connector part are plugged together, the threaded sections can be inserted in the associated unthreaded sections of the connector part and the mating connector part, respectively, in the direction of insertion. On the connector part and the mating connector part, two unthreaded and threaded sections each for the inner thread of the coupling ring respectively the outer thread of the threaded sleeve may be provided so that the coupling ring does not tilt when it is screwed onto the threaded sleeve.

The mating connector part may have a cut or a cast thread. With a cast thread, the two flattened thread areas caused by the production process may be considered unthreaded sections in terms of the invention. Typically, the threaded sections of the outer thread extend over 135 degrees each, and its unthreaded sections extend over 45 degrees each. Accordingly, 75% of the circumference of the outer thread is formed as a threaded area, and 25% as an unthreaded area. This ratio is correspondingly reversed on the circumference of the inner thread of the coupling ring. Thus, for locking purposes, the coupling ring can be rotated approximately 135 degrees, with a complete overlap of the threaded sections of the coupling ring of the connector part and of the threaded sleeve of the mating connector part.

In a preferred embodiment of the connector according to the invention, a rubber-elastic ring element is located between an attachment sleeve of the connector part that carries the coupling ring and the coupling ring itself. The ring element is overlapped and pressed by the coupling ring and acts as a friction brake. The friction brake acts upon the coupling ring in any position relative to the attachment sleeve. As a consequence, the restraint of the rotary motion is independent of the overlap in the direction of insertion of the inner thread of the coupling ring and the outer thread of the threaded sleeve of the mating connector part. This has the effect of providing a certain protection against an unintended separation of the connector part and the mating connector part of the electrical connector after a rotary locking of the electrical connector, even when the coupling ring is not tightened, i.e. when the face sides of the threaded sleeve and of the attachment sleeve are not pressed against each other. The rubber-elastic ring element prevents an unintended loosening of the coupling ring due to vibration or shock, and may also serve to seal the connector against environmental influences.

Below, the invention is explained in detail with reference to an embodiment shown in the drawing. Additional characteristics of the invention will be seen from the following description of the embodiment of the invention in conjunction with the claims and the attached drawing. The individual characteristics may be implemented each by themselves or in combinations of several in different embodiments of the invention.

### BRIEF DESCRIPTION OF THE DRAWINGS

FIG. 1 shows a perspective view of the electrical connector according to the invention in unplugged condition;

FIG. 2 shows a perspective view of the electrical connector in FIG. 1 in plugged-together and locked condition;

FIG. 3 shows an enlarged view of the threaded sleeve (FIG. 3a) and of the coupling ring (FIG. 3b) in FIG. 1 from a different angle of view; and

FIG. 4 shows an enlarged detail of the area around the coupling ring of the connector in FIG. 2 in plugged-together and locked condition in an axial section view.

### DETAILED DESCRIPTION OF THE INVENTION

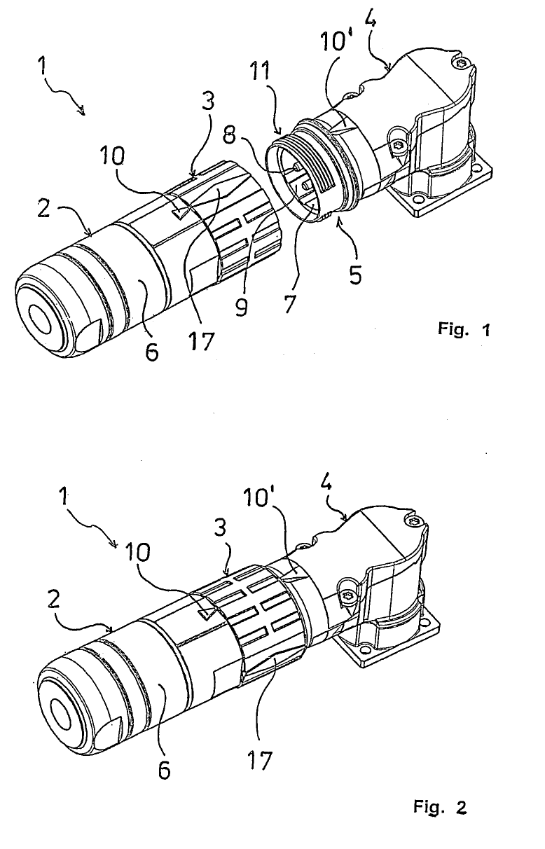

The electrical connector 1 according to the invention shown in FIG. 1, 2 comprises an oblong connector part 2 with a coupling ring 3 and a mating connector part 4 that has the form of an angle flange in this embodiment. The coupling ring 3 is rotatably fastened to the connector part 2 and serves to be screwed to a threaded sleeve 5 of the mating connector part 4. The connector part 2 can be plugged together with the mating connector part 4 exclusively in the position of the coupling ring 3 shown in FIG. 1 in relation to the body 6 of the connector part 2. In plugged-together condition, the connector part 2 and the mating connector part 4 can be locked together by rotating the coupling ring 3 by a maximum of 135 degrees.

The mating connector part 4 comprises a contact carrier 7 with contact elements 8 and a coding device 9 that are provided in a complementary manner on the connector part 2 but are not shown in the drawing. Connecting the connector part 2 with the mating connector part 4 of the connector 1 is only possible when the coding devices are in alignment, although they are covered by the coupling ring 3 when the connector 1 is plugged together. For the purpose of a simple alignment of the connector part 2 relative to the mating connector part 4, appropriate markings 10, 10′ are provided on the outer circumference of the connector part 2 and the mating connector part 4.

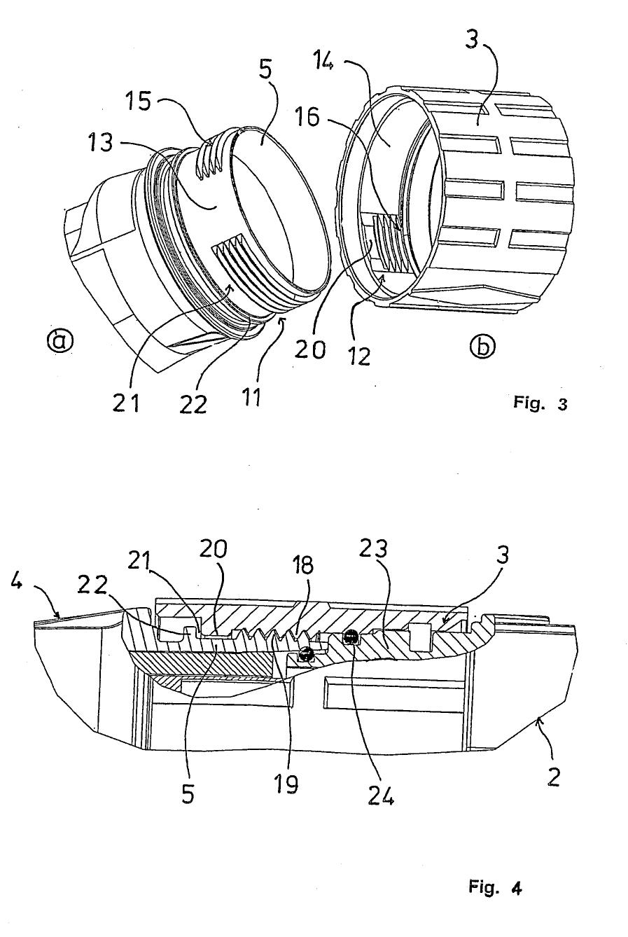

In order to screw the connector part to the mating connector part 4, an outer thread 11 is provided on the threaded sleeve 5, and an inner thread 12 that matches the outer thread 11 is provided on the coupling ring 3. As can be seen in FIG. 3a, b, the outer thread 11 and the inner thread 12 each have two unthreaded sections 13 and 14, respectively, and two threaded sections 15 and 16, respectively. The length of the threaded sections 15 of the threaded sleeve 5 measured in the circumferential direction corresponds essentially to the length of the unthreaded section 14 of the coupling ring 3, also as measured in the circumferential direction. Correspondingly, the lengths of the threaded sections 12 of the coupling ring 3 and the unthreaded sections 13 of the threaded sleeve 5 are implemented in relation to each other. This makes it possible that when the connector part 2 is plugged into the mating connector part 4, the threaded sections 15, 16 can be inserted, in the direction of insertion and with little play, into the associated unthreaded sections 13, 14 of the threaded sleeve 5 and the coupling ring 3, respectively.

Plugging together the connector part 2 and the mating connector part 4 is possible only when the unthreaded sections 13, 14 are in alignment with the associated threaded sections 15, 16. For the purpose of a simple and exact positioning in the circumferential direction of the coupling ring in relation to the connector part 2 and the mating connector part 4, the coupling ring has a marking 17 that, for plugging together as shown in FIG. 2, must be located opposite the markings 10, 10′ of the connector part 2 and of the mating connector part 4, respectively, and is determined by a stop.

In the embodiment of the connector according to the invention shown in the drawing, the inner thread 12 and the outer thread 11 are implemented as sharp threads, each with 4 courses of thread 18 and 19, respectively. The threads 11, 12 each have two threaded sections 15 and 16, respectively, and two unthreaded sections 13 and 14, respectively, that are located symmetrically in the circumferential direction on the coupling ring 3 and the threaded sleeve 5, respectively. Measured in the circumferential direction, the length of the threaded section 16 of the inner thread 12 is approximately ⅓ of the length of the associated threaded section 15 of the outer thread 11. The unthreaded sections 13, 14 of the threaded sleeve 5 and of the coupling ring 3 are implemented correspondingly. As a result, when the coupling ring 3 is rotated by an angle of almost 135 degrees, with complete radial overlap, the courses of thread 18 of the inner thread 12 engage the courses of thread 19 of the outer thread 11. This allows a corresponding extended motion range of the coupling ring 3 in the direction of insertion that depends exclusively on the thread pitch, thereby making the compensation of large tolerances of the mating connector part 4 possible.

As shown in FIGS. 3b, 4, in the direction of insertion and in front of the threaded section of the coupling ring 3, a raised annular collar section 20 is located that has a contour that is identical with the courses of thread 18 as seen in the direction of insertion. The raised annular collar section 20 extends in the direction of insertion by approximately 2 courses of thread 18 and prevents a rotation of the coupling ring 3 during the insertion of the connector part 2 into the mating connector part 4, as long as the raised annular collar section 20 is engaged in the unthreaded section 13 of the outer thread 11 of the threaded sleeve 5, i.e. between the two threaded sections 15. Only when the raised annular collar section 20 no longer rests between the unthreaded sections 13 of the outer thread 11 of the threaded sleeve 5 while the connector part 2 is being plugged together with the mating connector part 4, the coupling ring 3 can be rotated in the circumferential direction for the purpose of locking the connector 1.

Adjacent to the outer thread 11 on the threaded sleeve 5, an annular receptacle space 21 for the raised annular collar section 20 is provided that is limited by an annular collar 22 in the direction of insertion. The width of the receptacle space 21 is approximately 2.5 times the pitch of the outer thread 11. When rotated, the raised annular collar section 20 of the coupling ring 3 engages behind the threaded section 15 of the mating connector part 4 and, with the motion of the coupling ring 3 in the direction of insertion, is moved towards the annular collar 22 of the threaded sleeve 5.

Between the coupling ring 3 and an attachment sleeve 23 of the connector part 2 to which the coupling ring 3 is rotatably fastened, an O-ring serving as a rubber-elastic ring element 24 is located behind the inner thread 12 of the coupling ring 3 in the direction of insertion. As shown in FIG. 4, the O-ring 24 resting in a groove is overlapped and pressed by the coupling ring 3. Deformed elastically by the coupling ring 3, the O-ring 24 serves as a vibration brake for the connector 1 and prevents, by means of friction, an unintended disconnection of the connector part 2 from the mating connector part 4, and therefore a separation of the electrical connector 1.

1. An electrical connector, comprising a connector part and a mating connector part which can be plugged together, and a coupling ring, carried by the connector part, for screwing the connector part with a threaded sleeve of the mating connector part, with an outer thread of the threaded sleeve and a correspondingly configured inner thread of the coupling ring that are associated with each other having at least one unthreaded section each in the direction of insertion, and, adjacent to that in the circumferential direction, at least one threaded section, with the respective unthreaded and threaded sections being configured and arranged in such a manner that, when the connector part is plugged together with the mating connector part, the threaded sections can be inserted into the respective unthreaded sections of the connector part respectively the mating connector part, wherein at least one raised annular collar section is located in front of at least one threaded section of the coupling ring in the direction of insertion.

2. A connector according to claim 1, wherein the raised annular collar section and the threaded section in the circumferential direction of the coupling ring are of identical length and are in alignment with each other.

3. A connector according to claim 1, wherein the raised annular collar section and the threaded section of the coupling ring have an identical contour in the direction of insertion.

4. A connector according to claim 1, wherein a receptacle space for the raised annular collar section is provided in the direction of insertion behind a course of thread of the threaded section of the mating connector part.

5. A connector according to claim 1, wherein the raised annular collar section is arranged parallel to the courses of thread of the inner thread and has the form of a section of a course of thread.

6. A connector according to claim 1, wherein a length, in the circumferential direction, of the threaded section of the outer thread of the threaded sleeve amounts to a multiple of the threaded section of the inner thread of the coupling ring.

7. A connector according to claim 1, wherein, between an attachment sleeve of the connector part that carries the coupling ring and the coupling ring, a rubber-elastic ring element serving as a friction brake is located that is overlapped and pressed by the coupling ring.
